(19) United States
(12) Patent Application Publication
(10) Pub. No.: US 2026/0347210 A1
(43) Pub. Date: Nov. 5, 2026

(54) SYSTEM AND METHOD FOR MANUFACTURE OF CATHODE ACTIVE MATERIALS AND PRECURSORS THEREOF

(71) Applicant: UCHICAGO ARGONNE, LLC, Chicago, IL (US)

(72) Inventors: Ozgenur KAHVECIOGLU, Naperville, IL (US); Krzysztof Z. PUPEK, Plainfield, IL (US)

(73) Assignee: UCHICAGO ARGONNE, LLC, Chicago, IL (US)

(21) Appl. No.: 19/665,869

(22) Filed: May 1, 2026

Related U.S. Application Data
(60) Provisional application No. 63/798,128, filed on May 1, 2025.

(51) Int. Cl. C01G 53/51; B01J 19/06; B01J 19/24; C01G 53/40; H01M 4/505; H01M 4/525; H01M 10/054

(52) U.S. Cl. CPC C01G 53/51; B01J 19/06; B01J 19/2405; B01J 19/2415; C01G 53/40; C01P 2004/01; C01P 2006/40; H01M 4/505; H01M 4/525; H01M 10/054

(57) ABSTRACT

Systems and methods for stabilizing transition metal sulfate solutions for coprecipitation of pCAMs, especially stabilizing iron-containing transition metal sulfate solutions are described herein, which allow for improved continuous coprecipitation reactions for producing sodium-ion pCAMs without using large amounts/high concentrations of ammonia. The stabilized solutions enable more efficient and consistent production of Na-ion battery cathode materials, streamlining manufacturing processes for battery companies. This improvement provides cost savings and the delivery of higher quality products, and reduces reliance on expensive additives or complex purification steps. Furthermore, the disclosed methods for solution stabilization are scalable and suitable for large scale industrial production, using readily available hydroxycarboxylic acid materials as stabilizers.

### CROSS-REFERENCE TO RELATED APPLICATIONS

This application claims the benefit of U.S. Provisional Application Ser. No. 63/798, 128 filed on May 1, 2025, which is incorporated herein by reference in its entirety.

### STATEMENT OF GOVERNMENT INTEREST

The United States Government has rights in this invention pursuant to Contract No. DE-AC02-06CH11357 between the United States Government and UChicago Argonne, LLC representing Argonne National Laboratory.

### FIELD OF THE INVENTION

This invention relates to methods for stabilizing transition metal sulfate solutions for use in manufacturing cathode active materials and precursors thereof. More particularly, this invention relates to systems and methods for manufacturing cathode active materials and precursors thereof using stabilizers to keep transition metal sulfates from prematurely precipitating during cathode active material coprecipitation processes.

### BACKGROUND

Cathode active material (CAM) precursor materials (pCAMs) are typically prepared by coprecipitation of metal hydroxides, carbonates, or oxalates from metal sulfate solutions. The coprecipitates are mixed with a source of sodium (for sodium battery CAMs) or lithium (for lithium battery CAMs), and are then annealed at high temperatures to form CAMs such as sodium or lithium metal oxide CAMs. It is beneficial for the coprecipitate to be as homogeneous as possible with respect to distribution of the various metal salts that coprecipitate, in order to facilitate formation of relatively homogenous CAMs. Some metal sulfates, particularly iron sulfates, can be unstable in solution and may prematurely precipitate prior to or during mixing with other metal sulfates or may preferentially precipitate during the coprecipitation process, leading to inhomogeneous pCAMs or pCAMs that deviate from their target metal composition/proportions.

The global battery energy storage market is currently about $50 B, and is projected to grow by an order of magnitude over the next 10-15 years. Na-ion batteries that leverage lower cost and more earth abundant materials compared to Li-ion batteries, as well as improved low temperature performance, are a promising emerging technology for stationary and transportation battery applications. Sodium transition metal oxide battery CAMs of particular interest for current sodium battery applications often include significant amounts of iron within the transition metal oxide framework of the CAM. Iron-containing metal sulfates are particularly unstable and suffer from significant precipitation of iron oxides over relatively short storage periods. This leads to difficulties in coprecipitation of iron-containing pCAMs, requiring some form of stabilization of the metal sulfate solutions used for the coprecipitation.

Ammonia is the common chelating/complexing agent used incurrent pCAM production. Unfortunately, it is a weak complexing agent for pCAMs that contains Fe. In fact, when ammonia reacts with Fe²⁺, it causes Fe to oxidized to Fe³⁺, and forms Fe(OH)₃ which has a Ksp value of 21-25 orders of magnitude lower than that of Mn²⁺and Ni²⁺, while the other elements, such as Ni and Mn stay in metal complex forms in the reaction medium. For homogenous coprecipitation of a atomically well mixed Mn, Ni, Fe (and Co)-hydroxides; the Ksp values of each element should be close to each other (within 2-3 orders of magnitude is acceptable). Substantial differences in Ksp creates individual precipitation of elements in hydroxide form. As mentioned above, there is a need for a complexing agent that is strong enough to complex all elements (Ni, Mn, Fe), but should not be so strong as to inhibit transition metal hydroxide (TM(OH)₂) formation in alkaline reaction media.

There is an ongoing need for new systems and methods for coprecipitating cathode active material precursors. The methods and systems described herein address this need.

### SUMMARY

A method for stabilizing iron-containing transition metal sulfate aqueous solutions against oxidation and precipitation of transition metal oxides during storage is described herein. The solutions are stabilized by adding small amount (i.e., about 0.005 to 0.25 mol % based on total mole of transition metals) of a hydroxy-substituted carboxylic acid to the metal sulfate solution. The stabilized metal sulfate solution are useful as starting materials for coprecipitating pCAMs (e.g., transition metal hydroxides, carbonates, or oxalates) for use in preparing sodium and lithium cathode materials for sodium and lithium batteries.

By stabilizing the metal sulfates during the coprecipitation process. and reducing reliance on expensive additives or complex purification steps, the methods described herein offer a cost-effective approach to battery material synthesis. Furthermore, the disclosed methods for solution stabilization are scalable and suitable for large scale industrial production, enabling the mass manufacturing of Na-ion battery materials to meet the growing market demands. All of the stabilizers utilized in the methods described herein (hydroxycarboxylic acids, multidentate carboxylic acid complexing agents, and salts thereof) are non-hazardous and low cost. In fact, some are used in food industry for flavor enhancers and other uses. The stabilization of iron-containing transition metal (TM) sulfate solutions is achieved using hydroxycarboxylic acids and multidentate carboxylic acid complexing agents, without the need for ammonia to coordinate the unstable TM sulfate solutions (e.g., Fe-containing TM sulfates).

In one aspect, a method for stabilizing an iron-containing transition metal sulfate solution to prevent precipitation of metal oxides therefrom is provided. The method comprises adding about 0.005 to about 0.25 mol % of a stabilizing agent to an aqueous transition metal sulfate solution comprising iron sulfate in combination with at least one other transition metal sulfate, wherein the transition metal sulfate solution has a total transition metal concentration of about 0.2 to about 2 M (e.g., about 0.25 to 2 M). The stabilizing agent is a hydroxy-substituted carboxylic acid, a multidentate carboxylic acid complexing agent, or a salt thereof. Typical stabilizing agents include hydroxycarboxylic acids such as malic acid, tartaric acid, citric acid, isocitric acid, and the like, as well as salts thereof (e.g., ammonium salts), as well as unsubstituted multidentate carboxylic acids, such as oxalic acid, malonic acid, succinic acid, glutaric acid, and salts thereof. Precipitation of the transition metal oxides is prevented for extended periods of time (e.g., at least about 90 days at about 20 to 25 °C) after adding the stabilizing agent. This allows the metal sulfate solutions to be prepared stored ahead of pCAM manufacturing.

In another aspect, a method of coprecipitating iron-containing transition metal pCAMs is described herein. This method comprises mixing a solution of a precipitating agent (e.g., a basic material such as an alkali metal hydroxide, an alkali metal carbonate, or an alkali metal oxalate) with the stabilized iron-containing transition metal sulfate solution described above at a temperature and over a period of time sufficient to form a coprecipitate having a molar ratio of transition metals substantially the same as the ratio of transition metals in the iron-containing transition metal sulfate solution; and then isolating the coprecipitated pCAM. The resulting pCAM comprises an iron-containing transition metal hydroxide, carbonate, or oxalate, respectively, based on the alkali metal salt used as the precipitating agent. Optionally, an additional chelating agent can be added during the coprecipitation The additional chelating agent can be a hydroxycarboxylic acid, a multidentate carboxylic acid (such as a dicarboxylic acid or a tricarboxylic acid, and other carboxylic acids with multiple carboxylic acid functional groups (e.g., EDTA)), and other traditional chelating agents, including ammonia.

Sodium and lithium CAMs can be prepared by mixing the pCAM with an appropriate stoichiometric amount (or greater amount) of a sodium or lithium salt and calcining the mixture to produce the sodium or lithium CAM materials. Optionally, the transition metal hydroxide pCAMs can be heated in an oxygen-containing atmosphere at a temperature of about 300 to about 800 °C to convert the transition metal hydroxides in the pCAM to transition metal oxides (a process step referred to herein as “pre-treatment” “thermal pre-treatment”, or “PT”). The resulting transition metal oxides pCAMs can then be mixed with a sodium or lithium salt and calcined to produce sodium or lithium CAM materials as in the case with hydroxide pCAMs.

As used herein, the phrase “a coprecipitate having a molar ratio of transition metals substantially the same as the ratio of transition metals in the iron-containing transition metal sulfate solution” means that the molar percentage (mol %) of each transition metal in the coprecipitate (i.e., the mol % of each transition metal based on the total moles of transition metals) is within about 80 to about 100 percent of the mol % of transition metals in the iron-containing transition metal sulfate solution used in the coprecipitation reaction.

In another aspect, a system for coprecipitating iron-containing transition metal pCAMs is described herein. This system comprises a first reservoir containing the stabilized iron-containing transition metal sulfate solution; a second reservoir containing an aqueous solution of a precipitating agent selected from the group consisting of an alkali metal hydroxide, an alkali metal carbonate, and an alkali metal oxalate; a temperature-controlled reactor vessel comprising a mixing apparatus; a first pump adapted and arranged to continuously convey a flow of the stabilized iron-containing transition metal sulfate solution into the reaction vessel; and a second pump adapted and arranged to continuously convey a flow the solution of the precipitating agent into the reaction vessel at the same time as the first pump conveys the stabilized iron-containing transition metal sulfate solution into the reaction vessel. In use, the solution of the precipitating agent and the stabilized iron-containing transition metal sulfate solution are mixed together in or before reaching the reaction vessel and thereby react to form a coprecipitate of the transition metal hydroxide pCAM. The reaction vessel can be a tank reactor for batch reactions, a tank reactor with an overflow outlet to allow continuous or semicontinuous formation of the pCAM, a tubular continuous flow reactor in which the mixing apparatus is an in-line static mixer situated ahead of the continuous flow reactor, or a Taylor vortex reactor which also acts as its own mixing apparatus.

The following non-limiting embodiments are provided to illustrate certain aspects and features of the methods described herein.

Embodiment 1 is a method of stabilizing an iron-containing transition metal sulfate solution to prevent precipitation of metal oxides therefrom; the method comprising adding about 0.005 to about 0.25 mol % of a stabilizing agent to an aqueous transition metal sulfate solution comprising iron sulfate in combination with at least one other transition metal sulfate, wherein the transition metal sulfate solution has a total transition metal concentration of about 0.2 to about 2 M; the stabilizing agent is at least one hydroxycarboxylic acid, multidentate carboxylic acid, or a water soluble salt thereof (e.g., a hydroxy-substituted a hydroxy-substituted carboxylic acid, a hydroxy-substituted dicarboxylic acid, a hydroxy-substituted tricarboxylic acid, a C2 to C6 dicarboxylic acid, a C4 to C6 tricarboxylic acid, or a water-soluble salt of any of the foregoing); wherein precipitation of the metal oxides is prevented for at least about 90 days at about 20 to 25 °C, after adding the stabilizing agent.

Embodiment 2 is the method of embodiment 1, wherein the stabilizing agent is selected from the group consisting of glycolic acid, lactic acid, 2-hydroxybutyric acid, 2-hydroxycaproic acid, 2,2-bis(hydroxymethyl) propionic acid, gluconic acid, mucic acid, malic acid, tartaric acid, citramalic acid, 3-hydroxy-3-methylglutaric acid, oxalic acid, succinic acid, citric acid, a combination of any of the foregoing, and a water-soluble salt of any of the foregoing.

Embodiment 3 is the method of embodiment 1 or embodiment 2, wherein the stabilizing agent is selected from the group consisting of malic acid, oxalic acid, tartaric acid, a combination of any of the foregoing, and a salt of any of the foregoing.

Embodiment 4 is the method of any one of embodiments 1 to 3, wherein the at least one other transition metal sulfate comprises manganese sulfate, nickel sulfate, or a combination thereof.

Embodiment 5 is a stabilized iron-containing transition metal sulfate solution comprising about 0.005 to about 0.02 mol % (e.g., 0.01 to 0.02 mol %) of a stabilizing agent in an aqueous transition metal sulfate solution comprising iron sulfate in combination with at least one other transition metal sulfate, wherein the transition metal sulfate solution has a total transition metal concentration of about 1 to about 2 M; the stabilizing agent is a hydroxy-substituted carboxylic acid, a multidentate carboxylic acid, or a water-soluble salt thereof, and the stabilized iron-containing transition metal sulfate solution is substantially free of precipitated transition metal oxide.

Embodiment 6 is the solution of embodiment 5, wherein the stabilizing agent is selected from the group consisting of glycolic acid, lactic acid, 2-hydroxybutyric acid, 2-hydroxycaproic acid, 2,2-bis(hydroxymethyl) propionic acid, gluconic acid, mucic acid, malic acid, tartaric acid, citramalic acid, 3-hydroxy-3-methylglutaric acid, oxalic acid, succinic acid, citric acid, a combination of any of the foregoing, and a water-soluble salt of any of the foregoing.

Embodiment 7 is the solution of embodiment 5 or embodiment 6, wherein the stabilizing agent is selected from the group consisting of malic acid, oxalic acid, tartaric acid, a combination of any of the foregoing, and a salt of any of the foregoing.

Embodiment 8 is the solution of any one of embodiments 5 to 7, wherein the at least one other transition metal sulfate comprises manganese sulfate, nickel sulfate, or a combination thereof.

Embodiment 8 is a method of coprecipitating an iron-containing transition metal cathode active material precursor salt (pCAM) from the stabilized iron-containing transition metal sulfate solution of any one of embodiments 5 to 8; the method comprising the steps of:
(a) mixing a solution of a precipitating agent with the stabilized iron-containing transition metal sulfate solution at a temperature in the range of about 20 to about 50 °C, over a period of time sufficient to form a coprecipitate having a molar ratio of transition metals substantially the same as the ratio of transition metals in the iron-containing transition metal sulfate solution; and
(b) isolating the coprecipitated pCAM;
wherein the precipitating agent comprises an aqueous solution of an alkali metal salt selected from the group consisting of an alkali metal hydroxide, an alkali metal carbonate, and an alkali metal oxalate; and the pCAM comprises an iron-containing transition metal hydroxide, carbonate, or oxalate, respectively, based on the alkali metal salt used as the precipitating agent.

Embodiment 9 is the method of embodiment 8, wherein the alkali metal salt is a sodium salt or a lithium salt.

Embodiment 10 is the method of embodiment 8 or embodiment 9, wherein the mixing is achieved by simultaneously pumping the solution of the precipitating agent and the iron-containing transition metal sulfate solution into a vessel comprising an aqueous medium.

Embodiment 11 is the method of any one of embodiments 7 to 10, further comprising mixing an aqueous solution of a chelating agent with the stabilized iron-containing transition metal sulfate solution and the solution of the precipitating agent.

Embodiment 12 is the method of any one of embodiments 7 to 10, wherein the mixing is achieved by simultaneously pumping the solution of the precipitating agent and the iron-containing transition metal sulfate solution through a tubular continuous flow reactor or a Taylor vortex reactor.

Embodiment 13 is the method of any one of embodiments 7 to 12, further comprising forming a mixture of the pCAM isolated in step (b) with an alkali metal salt in a stoichiometric ratio required to prepare a cathode active material therefrom; and
calcining the mixture at a temperature in the range of about 425 to about 900 °C for a period of time sufficient to form the cathode active material from the mixture; wherein the cathode active material is an alkali metal-transition metal oxide; and the alkali metal is selected from the group consisting of sodium and lithium.

Embodiment 14 is a system for coprecipitating an iron-containing transition metal cathode active material precursor salt (pCAM) from a stabilized iron-containing transition metal sulfate solution; the system comprising:
a first reservoir containing the stabilized iron-containing transition metal sulfate solution;
a second reservoir containing an aqueous solution of a precipitating agent selected from the group consisting of an alkali metal hydroxide, an alkali metal carbonate, and an alkali metal oxalate;
a temperature-controlled reactor vessel comprising a mixing apparatus within or ahead of the reactor vessel;
a first pump adapted and arranged to continuously convey a flow of the stabilized iron-containing transition metal sulfate solution into the reaction vessel;
a second pump adapted and arranged to continuously convey a flow the solution of the precipitating agent into the reaction vessel at the same time as the first pump conveys the stabilized iron-containing transition metal sulfate solution into the reaction vessel;
wherein in use, the solution of the precipitating agent and the stabilized iron-containing transition metal sulfate solution are mixed together within or before entering the reactor and thereby react to form a coprecipitate of the pCAM; and the stabilized iron-containing transition metal sulfate solution comprises about 0.005 to about 0.25 mol % of a stabilizing agent in an aqueous transition metal sulfate solution comprising iron sulfate in combination with at least one other transition metal sulfate; the transition metal sulfate solution has a total transition metal concentration of about 0.25 to about 2 M; the stabilizing agent is a hydroxy-substituted carboxylic acid, a multidentate carboxylic acid, or a water-soluble salt thereof, and the stabilized iron-containing transition metal sulfate solution is substantially free of precipitated transition metal oxide.

Embodiment 15 is the system of embodiment 14, wherein the reaction vessel is a tubular continuous flow reactor, and the mixing apparatus is an in-line static mixer situated ahead of the continuous flow reactor; or the reaction vessel is a Taylor vortex reactor which also acts as its own mixing apparatus.

Embodiment 16 is the system of embodiment 14 or embodiment 15, further comprising:
a third reservoir containing an aqueous solution of a chelating agent; and
a third pump adapted and arranged to continuously convey a flow of the solution of the chelating agent into the reaction vessel at the same time as the first pump conveys the stabilized iron-containing transition metal sulfate solution into the reaction vessel;
wherein in use, the solution of the chelating agent, the solution of the precipitating agent, and the stabilized iron-containing transition metal sulfate solution are mixed together in the reaction vessel and thereby react form the coprecipitate of the pCAM.

Embodiment 17 is the system of any one of embodiments 14 to 16, wherein the stabilizing agent is selected from the group consisting of glycolic acid, lactic acid, 2-hydroxybutyric acid, 2-hydroxycaproic acid, 2,2-bis(hydroxymethyl) propionic acid, gluconic acid, mucic acid, malic acid, tartaric acid, citramalic acid, 3-hydroxy-3-methylglutaric acid, oxalic acid, succinic acid, citric acid, a combination of any of the foregoing, and a water-soluble salt of any of the foregoing.

Embodiment 18 is the system of any one of embodiments 14 to 16, wherein the stabilizing agent is selected from the group consisting of malic acid, oxalic acid, tartaric acid, a combination of any of the foregoing, and a salt of any of the foregoing.

Embodiment 17 is the system of any one of embodiments 14 to 18, wherein the at least one other transition metal sulfate comprises manganese sulfate, nickel sulfate, or a combination thereof.

Embodiment 18 is the system of any one of embodiments 14 to 17, wherein the alkali metal salt is a sodium salt or a lithium salt.

### BRIEF DESCRIPTION OF THE DRAWINGS

FIG. 1 schematically illustrates a coprecipitation system for performing the methods described herein.

FIG. 2 schematically illustrates an alternative coprecipitation system for performing the methods described herein.

FIG. 3 provides a summary of selected continuous coprecipitation experiments conducted with a TVR reactor

FIG. 4 illustrates the morphology a Mn_{0.50}Ni_{0.40}Fe_{0.10}(OH)₂ pCAM produced in a TVR

FIG. 5 provides the particle size distribution of the pCAM shown in FIG. 4.

FIG. 6 provides a graphical table showing the precursors (top row) produced from different continuous coprecipitation processes and the resulting sodiated cathodes (bottom row).

FIG. 7 provides results for batch coprecipitations from a solution of Mn_{0.33}Ni_{0.33}Fe_{0.33}SO₄, stabilized with different amounts of tartaric acid (Stab A) using oxalate as the precipitating agent to form a pCAM of formula Mn_{0.33}Ni_{0.33}Fe_{0.33}(Ox), wherein Ox is oxalate.

FIG. 8 provides results for batch coprecipitations from a solution of Mn_{0.50}Fe_{0.50}SO₄, stabilized with different amounts of tartaric acid (Stab A) using oxalate as the precipitating agent to form a pCAM of formula Mn_{0.50}Fe_{0.50}(Ox), wherein Ox is oxalate.

FIG. 9 provides results for batch coprecipitations from a solution of Mn_{0.50}Fe_{0.50}SO₄, stabilized with different amounts of ammonium tartrate using oxalate as the precipitating agent to form a pCAM of formula Mn_{0.50}Fe_{0.50}(Ox), wherein Ox is oxalate.

FIG. 10 provides results for a continuous coprecipitation using oxalate solution as the precipitating agent in a continuous flow reactor (CFR) as illustrated in FIG. 2, in which the transition metal sulfate was Mn_{0.50}Fe_{0.50}SO₄, stabilized with tartaric acid or ammonium tartrate.

FIG. 11 provides results for a continuous coprecipitation using oxalate solution as the precipitating agent in a continuous flow reactor (CFR) as illustrated in FIG. 2, in which the transition metal sulfate was Mn_{0.33}Ni_{0.33}Fe_{0.33}SO₄, stabilized with tartaric acid or ammonium tartrate.

FIG. 12 provides electron micrographic images at magnifications of 20000× of roughly spherical particles of transition metal hydroxide pCAM examples SF-18 (Panel A) and SF-19 (Panel B), and the densities of the pCAMs. The particles in Panel A range from about 3 to about 6 μm in diameter; whereas the main particle in Panel B is about 12 μm in diameter.

FIG. 13 provides electron micrographic images of the transition metal hydroxide pCAM particles (Panel A) and a graphical illustration of the particle size distribution (Panel B) of the material of Ex. SF-18. In Panel A, the images are at the following magnifications 1000× (upper left), 2500× (upper right), 10000× (lower left); and 25000× (lower right).

FIG. 14 provides electron micrographic images of the transition metal hydroxide pCAM particles (Panel A) and a graphical illustration of the particle size distribution (Panel B) of the material of Ex. SF-19. In Panel A, the images are at the following magnifications 1000× (upper left), 2500× (upper right), 10000× (lower left); and 25000× (lower right).

FIG. 15 shows electron micrographic images of the transition metal oxide pCAM particles (Panel A, far right) resulting from thermal pre-treatment of Ex. SF-18 at three different temperatures (300, 400, and 500 °C) under an oxygen atmosphere, as well as the densities of the resulting transition metal oxide pCAMs.

FIG. 16 provides electron micrographic images of sodium CAMs produced from transition metal oxide pCAMs SF-18-PT3 (Panel A) and SF-18-PT5 (Panel B) by calcination with sodium carbonate at 500 °C for 5 hours and 850 °C for 12 hours in an oxygen atmosphere.

### DETAILED DESCRIPTION

Methods of stabilizing transition metal sulfate solutions for coprecipitation of pCAMs, especially stabilizing iron-containing transition metal sulfate solutions are described herein, which allow for improved continuous coprecipitation reactions for producing sodium-ion and lithium-ion pCAMs without using large amounts/high concentrations of ammonia. In particular, the stabilized solutions enable more efficient and consistent production of Na-ion battery cathode materials, streamlining manufacturing processes for battery companies. This improvement provides cost savings and the delivery of higher quality products with minimal impurities or variations in quality.

The mixed metal sulfate solutions for preparing sodium CAMs typically comprise iron sulfate and one or more additional transition metal sulfates, such as nickel sulfate, and manganese sulfate, for example. The transition metal sulfates are present in the stabilized TM sulfate solution at concentrations in the range of about 0.2 to about 2 M (e.g., about 1 to about 2 M) for each TM sulfate in the solution. The ratio of different TM sulfates is selected based on the TM stoichiometry of the target pCAM and CAM of interest. For example, for NaMn_{0.5}Ni_{0.4}Fe_{0.1}O₂ as the target CAM, the ratio of Mn:Ni:Fe would be about 5:4:1.

The stabilizing agents utilized in the system and methods described herein are water soluble hydroxy-substituted carboxylic acids (also known as “hydroxycarboxylic acids”), multidentate carboxylic acids, and salts thereof (e.g., sodium or ammonium salts), typically C2 to C6 hydroxycarboxylic acids, including hydroxy-substituted-monocarboxylic acids (e.g., glycolic acid, lactic acid, 2-hydroxybutyric acid, 2-hydroxycaproic acid, 2,2-bis(hydroxymethyl) propionic acid, gluconic acid, mucic acid, and the like); hydroxy-substituted dicarboxylic acids, typically Cto C6 hydroxy-substituted dicarboxylic acids (e.g., malic acid, tartaric acid, citramalic acid, 3-hydroxy-3-methylglutaric acid, and the like);

hydroxy-substituted tricarboxylic acids (e.g., citric acid and the like), dicarboxylic acids such as oxalic acid, malonic acid, succinic acid, and the like, as well as water soluble salts of such acids, such as sodium or ammonium salts. In some embodiments, the stabilizing agent is tartaric acid or a tartaric acid salt such as ammonium tartrate. In some other embodiments, the stabilizing agent is oxalic acid, malic acid, and salts thereof. The stabilizing agent typically is included in the mixed transition metal sulfate solution at a concentration in the range about 0.005 to about 0.25 mol %, preferably about 0.01 to about 0.125 mol % (e.g., about 0.1 mol %) based on moles of transition metal sulfates in the solution.

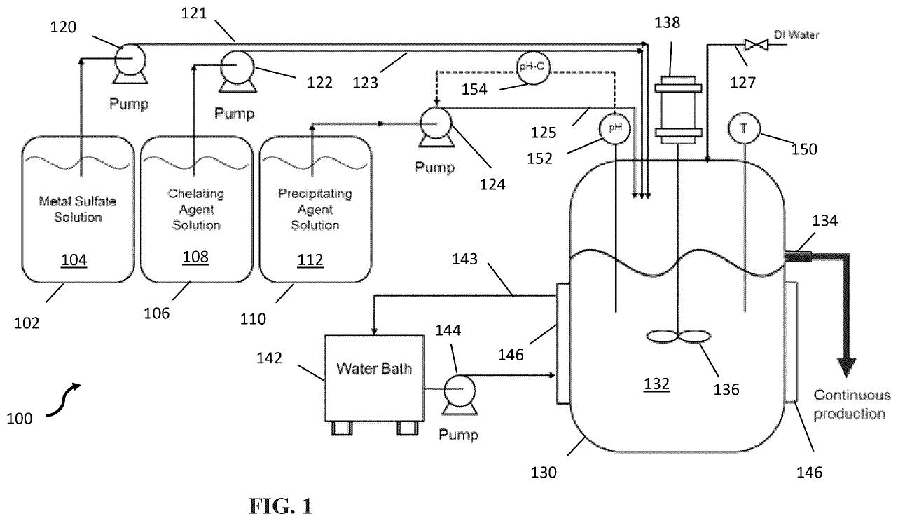

FIG. 1 schematically illustrates an embodiment of a system for performing the coprecipitation methods described herein. System 100 includes metal sulfate supply vessel 102 containing a stabilized transition metal solution 104 as described herein (e.g., containing an aqueous mixture of transition metal sulfates and a hydroxy-substituted carboxylic acid chelating agent); an optional chelating solution supply vessel 106 containing a chelating solution 108 (e.g., a hydroxy-substituted carboxylic acid, a multidentate carboxylic acid, or another chelating agent); and a precipitating agent supply vessel 110, containing precipitating agent solution 112 (e.g., aqueous sodium hydroxide, sodium carbonate, an oxalate salt, and the like). The solutions in vessels 102, 106 and 110 are pumped into reaction medium 132 (e.g., water) within reaction vessel 130 via pumps 120, 122, and 124, respectively, through feed lines 121, 123, and 125, respectively. Mixed transition metal salts (e.g., transition metal hydroxides, carbonates, or oxalates) continuously coprecipitate within medium 132, which is stirred by mechanical stirrer 136 powered by motor 138. A portion of reaction medium 132 and the coprecipitated salts are continuously discharged through discharge port 134 which acts as an overflow outlet to allow continuous or semicontinuous coprecipitation. The temperature of the reaction medium is monitored via temperature probe 150, and the temperature is controlled by a recirculating temperature jacket 146 supplied by water bath 142 and pump 144 via recirculating loop 143. The pH of the reaction medium is monitored by pH probe 152 which is in communication with pH feedback controller 154. Controller 154 controls the pumping rate of pump 124 and thus the flow of the precipitating agent into medium 132, e.g., in response to deviations from a set pH target value. Additional chelator solution 108 and associated vessel 106, pump 122 and feed line 123 are optional, but preferred.

In use, the stabilized TM sulfate solution 104, optional chelating solution 108, and precipitation agent solution 112 are simultaneously pumped into reaction medium 132 to coprecipitate a transition metal hydroxide pCAM. The pumping rates and concentrations of the TM sulfates, chelation agent, and precipitating agent are selected to afford the desired stoichiometry for the targeted pCAM composition. The coprecipitation is dependent on pH, so the pH is monitored by probe 152 and the pumping rate of pump 124 is controlled by pH controller 154 in response to how the pH of the reaction medium 132 varies from the target pH for the coprecipitation.

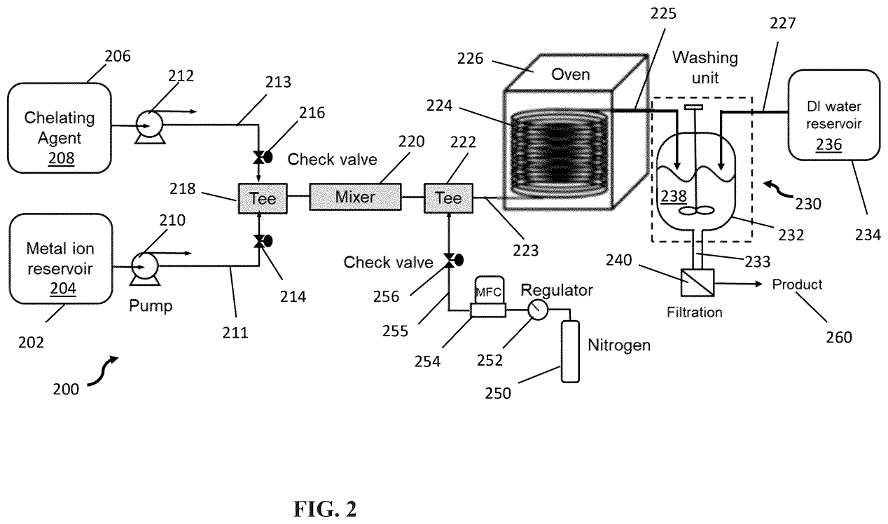

FIG. 2 schematically illustrates an alternative system for performing the coprecipitation methods described herein. System 200 includes metal sulfate supply vessel 202 containing a stabilized transition metal solution 204 as described herein (e.g., containing an aqueous mixture of transition metal sulfates and a stabilizing agent, e.g., aqueous tartaric acid or other hydroxy-substituted carboxylic acid); and supply vessel 206 containing solution 208 comprising the precipitating agent (e.g., a hydroxide, carbonate, or oxalate) and optionally a chelating agent. When oxalate pCAMs are prepared, oxalate acts as both a precipitating agent and a chelating agent. The solutions in vessels 202 and 206 are pumped into Tee junction 218 via pumps 210 and 212, respectively, through feed lines 211 and 213, respectively. Check valves 214 and 216 prevent backflow. Tee junction 218 feeds into static mixer 220 which mixes the precipitating agent solution 208 with the stabilized TM ion solution 204.

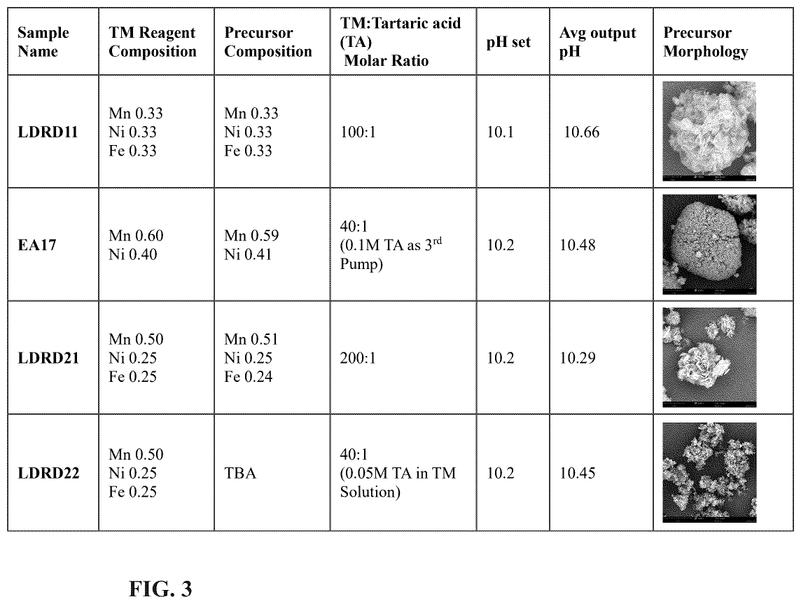

Mixer 220 feeds into Tee junction 222, optionally connected to a low interrupter system comprising gas supply tank 250, which feeds gas into regulator 252 and mass flow controller (MFC) 255 to supply intermittent bursts of gas (e.g., nitrogen) from tank 250 through regulator 252 and MFC 254 into the Tee junction 222 via gas line 255. This creates bubbles in the solution flowing into the tube reactor, thereby creating small plugs of solution, and creating independent reaction zones for the precipitation reaction (see FIG. 3). Check valve 256 prevents the solution in Tee junction 222 from backing into the gas line 255. The mixture of metal ions and precipitating agent (and optional chelating agent) feeds into tube reactor 224 within oven 226 via feed line 223. The mixed solution travels through tube reactor 224 and the desired transition metal hydroxide pCAM precipitates within tube reactor 224 and discharges via discharge line 225 into washing tank 232 of washing unit 230, containing DI water forming a suspension 238. Suspension 238 is discharged vias outlet 223 into filter unit 240, from which pCAM product 260 is isolated.

Alternatively, the tube reactor 224 in FIG. 2 can be replaced with a Taylor vortex reactor (TVR), eliminating the need for the flow interrupter. TVRs are well known in the chemical arts, and utilize a fluid motion generated in a small gap between a rotating inner cylinder concentric with a stationary outer cylinder. When the rotational speed of the inner cylinder exceeds a critical value, fluid flow in the gap between the cylinders changes from laminar flow to what is known as Taylor vortex flow, in which counter-rotating toroidal vortices form in the flowing reaction solution. Eddy currents within the vortices create very strong, homogenous micro-mixing zones with high mixing force and mass transfer rates.

Cathode materials are prepared by calcining a mixture of the transition metal hydroxide pCAM and an appropriate stoichiometric amount (or a slight excess, e.g., 1 to 20 % excess) of a sodium or lithium salt (e.g., a hydroxide, oxalate, or carbonate) at a temperature in the range of about 425 to about 950 °C to form a sodium or lithium CAM, respectively, as is well known in the lithium and sodium battery arts.

Alternatively, the transition metal hydroxide pCAM can be heated at a temperature of about 300 to about 800 °C in an oxygen atmosphere to convert to the transition metal hydroxide pCAM to a transition metal oxide pCAM, prior to calcining with the sodium or lithium salt. This optional heating step typically results in a higher density transition metal oxide pCAM, and thus a higher density CAM compared to CAMs produced without pre-treatment. Higher density sodium or lithium CAMs are desirable for improved energy density in rechargeable battery applications.

### Example 1. TVR Continuous Coprecipitation of pCAMs

A series of continuous coprecipitation experiments were conducted using a TVR to synthesize transition metal precursors for cathodes of sodium-ion batteries. Various transition metal sulfate solutions containing iron, including Mn_{0.50}Ni_{0.25}Fe_{0.25}SO₄ (MNF211), Mn_{0.33}Ni_{0.33}Fe_{0.33}SO₄ (MNF111), and other metal sulfate compositions, were stabilized with hydroxycarboxylic acids, such as ammonium tartrate, tartaric acid, or citric acid at different molar ratios. For hydroxide-based coprecipitation experiments, NaOH was primarily used as the precipitating agent. For oxalate-based coprecipitation, an oxalate solution was employed as the precipitating agent.

A summary of selected continuous coprecipitation experiments conducted with the TVR is presented in the table in FIG. 3, where tartaric acid was used as a stabilizing agent.

Information on both the desired composition for the experiment and the transition metal ratio in the prepared solution is provided in the “TM Reagent Composition” column. The transition metal ratio of the resulting precursor material, confirmed by ICP analysis, is shown in the “Precursor Composition” column. The amount of tartaric acid added to stabilize Fe-containing transition metal solutions is described in the “TM:Tartaric Acid (TA) Molar Ratio” column. In all samples listed, except for EA17, tartaric acid was included in the transition metal solution as a stabilizer that also functioned as a chelator, with NaOH used as the precipitating agent. For EA17, which lacked Fe in the transition metal solution, tartaric acid was used solely as a chelator and was prepared separately as a reagent pumped into the reactor, while NaOH served as the precipitating agent. The target pH value that was established is represented in the “pH set” column, whereas the actual pH of the output solution, which was recorded hourly, is provided in the “Avg output pH” column. SEM images of the materials produced in the experiments are presented in the “Precursor Morphology” column. Through this table, the influence of morphology can be inferred based on the transition metal composition and the amount of tartaric acid used.

### MNF111-Continuous Hydroxide Coprecipitation at 50 °C

A Mn_{0.33}Ni_{0.33}Fe_{0.33}SO₄ solution stabilized with 0.02M ammonium tartrate (AT), with an AT:TM molar ratio of 1:100 was continuously coprecipitated with sodium hydroxide using a TVR reactor to form Mn_{0.33}Ni_{0.33}Fe _{0.33}(OH)₂. Steady-state conditions were achieved by 19 hours and were maintained for an additional 6 hours. This hydroxide coprecipitation delivered secondary particles with near-spherical morphology.

### MNF541-Continuous Hydroxide Coprecipitation at 50 °C

In this continuous TVR coprecipitation experiment, a Mn_{0.50}Ni_{0.40}Fe_{0.10}SO₄ solution, stabilized with ammonium tartrate (Stabilizer: TM molar ratio of 1:50), was utilized as the transition metal solution. NaOH solution was continuously added as the precipitating agent.

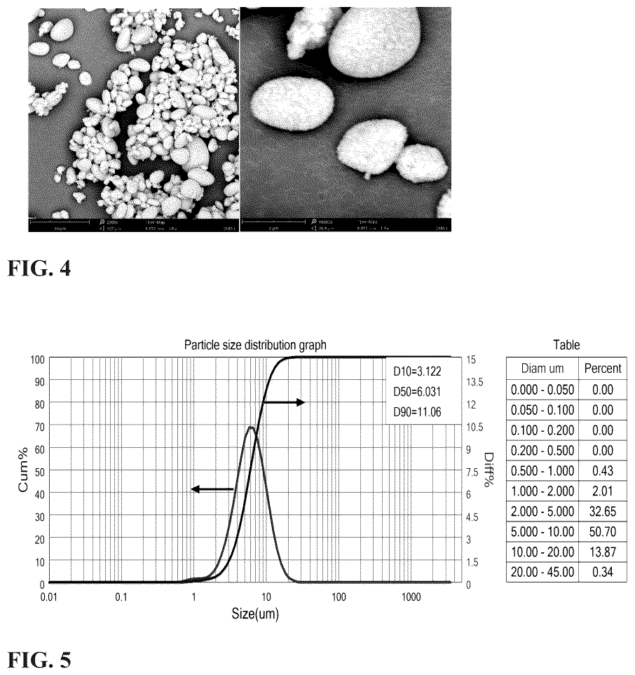

This coprecipitation provided a Mn_{0.50}Ni_{0.40}Fe_{0.10}(OH)₂ pCAM with a relatively smooth morphology, as shown in FIG. 4, having a particle size distribution shown in FIG. 5.

### MNF(211) Continuous Hydroxide Coprecipitation at 50 °C

In this continuous TVR coprecipitation experiment, a Mn_{0.50}Ni_{0.25}Fe_{0.25}SO₄ solution, stabilized with 0.02M tartaric acid (Stabilizer: TM molar ratio of 1:100), was utilized as the transition metal solution. A separate 0.1M tartaric acid solution was added as an additional chelator, while a NaOH solution was applied as the precipitating agent, to afford a coprecipitate of formula Mn_{0.50}Ni_{0.25}Fe_{0.25}(OH)₂.

### Example 2. Comparison of pCAMs Made via Continuous Coprecipitation With the Corresponding CAM Products

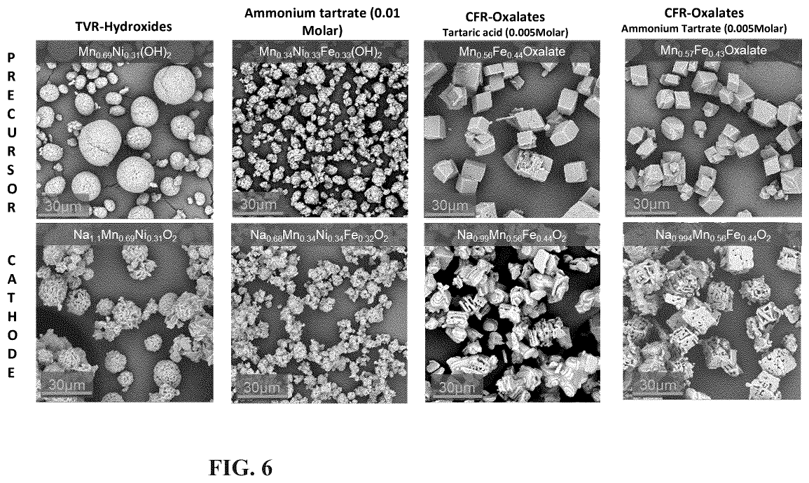

The graphical table in FIG. 6 is presented with the precursors (top row) produced from different continuous processes and the resulting sodiated cathodes (bottom row). The “TVR-Hydroxides” column, denoted in green text, represents an experiment conducted using the TVR reactor with an Mn_{0.65}Ni_{0.35}SO₄ solution as the transition metal solution, NH4OH solution as the chelator, and NaOH solution as the precipitating agent. The “Ammonium Tartrate (0.01 Molar)” column, denoted in blue text, corresponds to an experiment using the TVR reactor, where an Mn_{0.33}Ni_{0.33}Fe_{0.33}SO₄ solution stabilized with ammonium tartrate, which also functioned as a chelator, was used. NaOH solution was used as the precipitating agent. The “CFR-Oxalates Tartaric Acid (0.005M)” column, denoted in red text, represents an experiment performed using the continuous flow reactor (CFR) with an Mn_{0.65}Ni_{0.35}SO₄ solution stabilized with 0.005M tartaric acid as the transition metal solution. An oxalate solution is used as the precipitating agent. The “CFR-Oxalates Ammonium Tartrate (0.005M)” column, denoted in dark gray text, corresponds to an experiment using the CFR with an Mn_{0.65}Ni_{0.35}SO₄ solution stabilized with 0.005M ammonium tartrate as the transition metal solution and an oxalate-type solution as the precipitating agent.

### Example 3. Oxalate Coprecipitation

A series of pCAMS were produced via batch and continuous flow reactor (CFR) coprecipitations, using oxalate as the precipitating agent and various TM sulfate solutions stabilized with tartaric acid (TA) or ammonium tartrate (AT).

### Batch Production of MNF111 With Tartaric Acid (TA) Stabilizer at RT

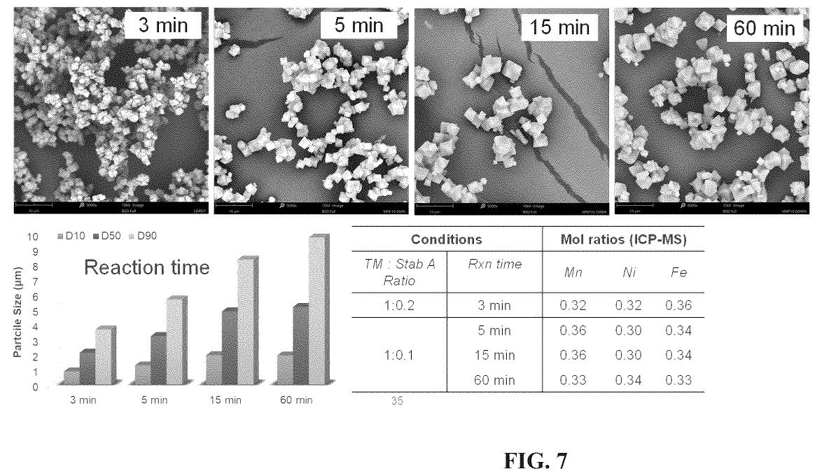

These batch reactions were conducted by adding a solution of Mn_{0.33}Ni_{0.33}Fe_{0.33}SO₄, stabilized with different amounts of tartaric acid (Stab A) using and oxalate solution as the precipitating agent to form a pCAM of formula Mn_{0.33}Ni_{0.33}Fe_{0.33}(Ox), wherein Ox is oxalate. Results are shown in the table in FIG. 7. Mixing of the stabilized TM sulfate solution and the oxalate solution was performed over different time periods, ranging from 5 minutes to 1 hour (see table: Rxn time). The resulting transition metal ratios of the resulting pCAMa were confirmed with ICP analysis.

### Batch Production of MF11 With TA Stabilizer

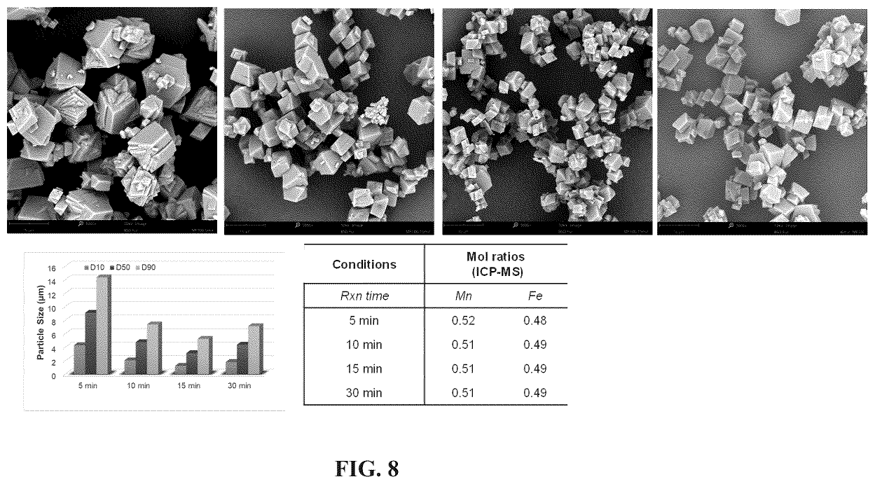

These batch reactions were conducted using a beaker. The transition metal used is Mn_{0.50}Fe_{0.50}SO₄, stabilized with tartaric acid, using an oxalate solution as the precipitating agent to form a pCAM of formula Mn_{0.50}Fe_{0.50}(Ox), wherein Ox is oxalate. The reaction is mixed for different times, ranging from 5 minutes to 30 minutes (see table: Rxn time). The resulting transition metal ratio of the precursor is confirmed with ICP analysis. Results are shown in FIG. 8.

### Batch Production of MF11 With AT Stabilizer

This batch reaction is conducted using a beaker. The transition metal used is Mn_{0.50}Fe_{0.50}SO₄, stabilized with ammonium tartrate, using an oxalate solution as the precipitating agent to form a pCAM of formula Mn_{0.50}Fe_{0.50}(Ox), wherein Ox is oxalate. The reaction is mixed for different times, ranging from 5 minutes to 30 minutes (see table: Rxn time). The resulting transition metal ratio of the precursor is confirmed with ICP analysis.

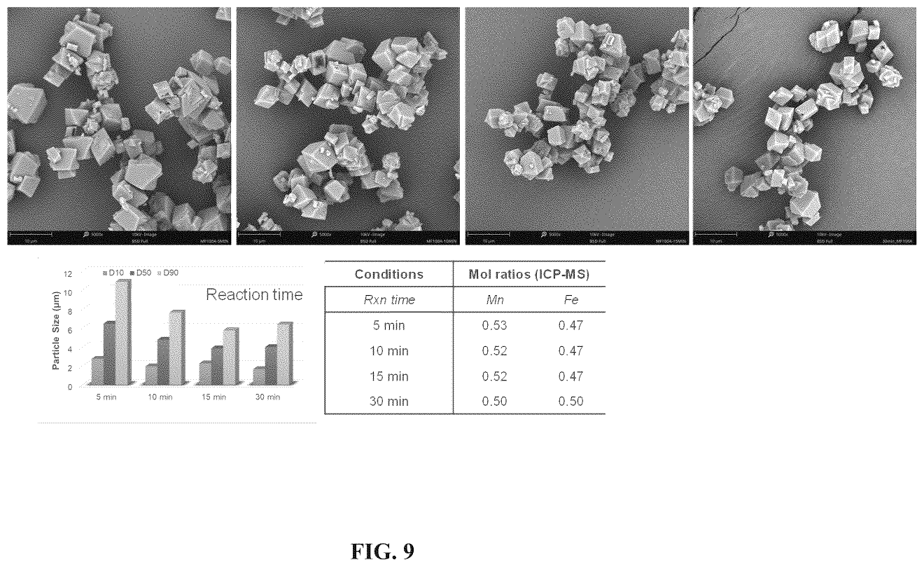

Results are shown in FIG. 9.

### Continuous Flow Reactor (CFR) Production of Mf11 and MNF111 With TA or AT Stabilizers

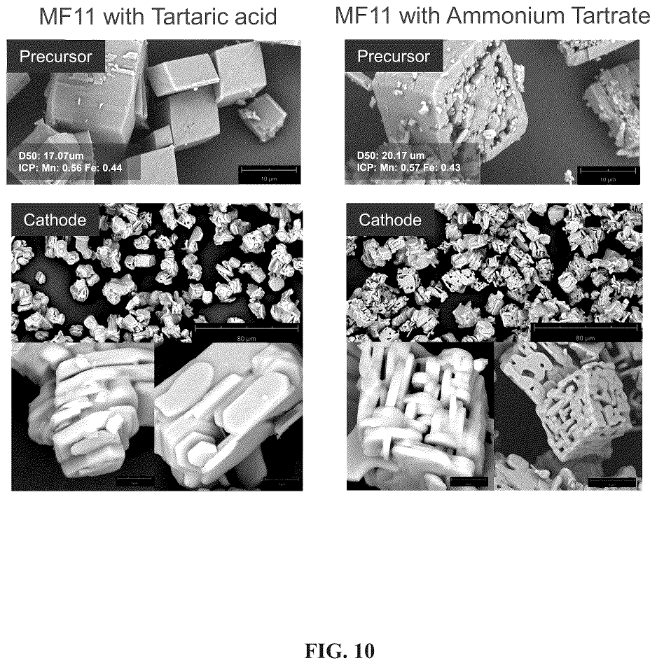

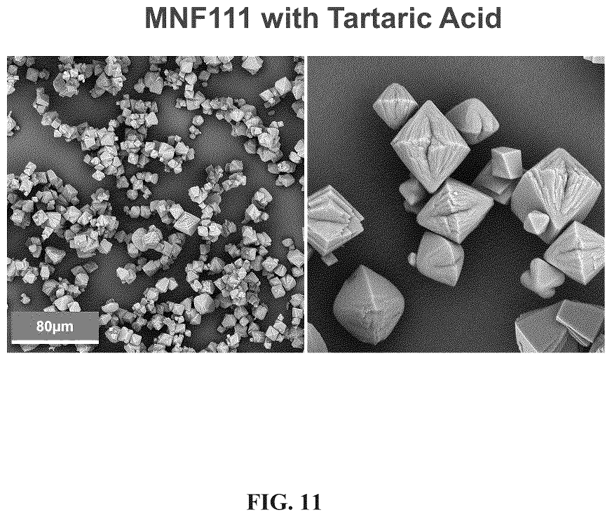

This continuous reaction was conducted using a continuous flow reactor (CFR) as illustrated in FIG. 2. The transition metal sulfate used was used is Mn_{0.50}Fe_{0.50}SO₄ or Mn_{0.33}Ni_{0.33}Fe_{0.33}SO₄ or stabilized with either tartaric acid or ammonium tartrate. An oxalate solution is used as the precipitating agent. The two reactants are each fed at a rate of 5 mL/min at room temperature into the continuous flow reactor to form a coprecipitate of formula Mn_{0.50}Fe_{0.50}(Ox) or Mn_{0.33}Ni_{0.33}Fe_{0.33}(Ox), wherein Ox is oxalate. Results are shown in FIG. 10 for Mn_{0.50}Fe_{0.50}(Ox) and FIG. 11 for Mn_{0.33}Ni_{0.33}Fe_{0.33}(Ox) using tartaric acid.

### Example 4. Additional Examples of Transition Metal Hydroxide pCAMs Made With Added Malic Acid Chelating Agent

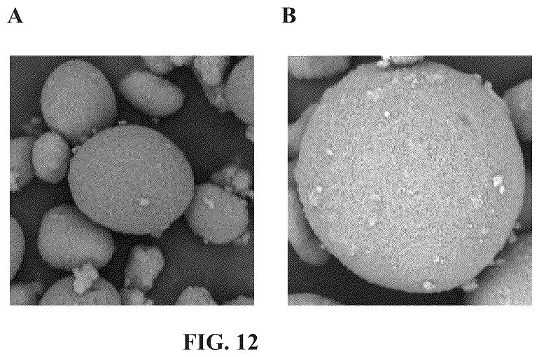

Aqueous MnSO₄, NiSO₄, and FeSO₄ hydrates were dissolved in water containing 0.05 molar equivalents of tartaric acid in a target ratio of Mn:Ni:Fe of about 0.375:0.25:0.375, and transition metal hydroxide pCAMs were co-precipitated following the procedures described above, using 4 M sodium hydroxide as the precipitating agent, while adding 2 M malic acid as a chelating agent (Ex. SF-18). The resulting product from Ex. SF-18 comprised roughly spherical particles and a density of about 1.45 g/mL and a molar ration of Mn:Ni:Fe of about 0.368:0.252:0.380 (see FIG. 12, Panel A).

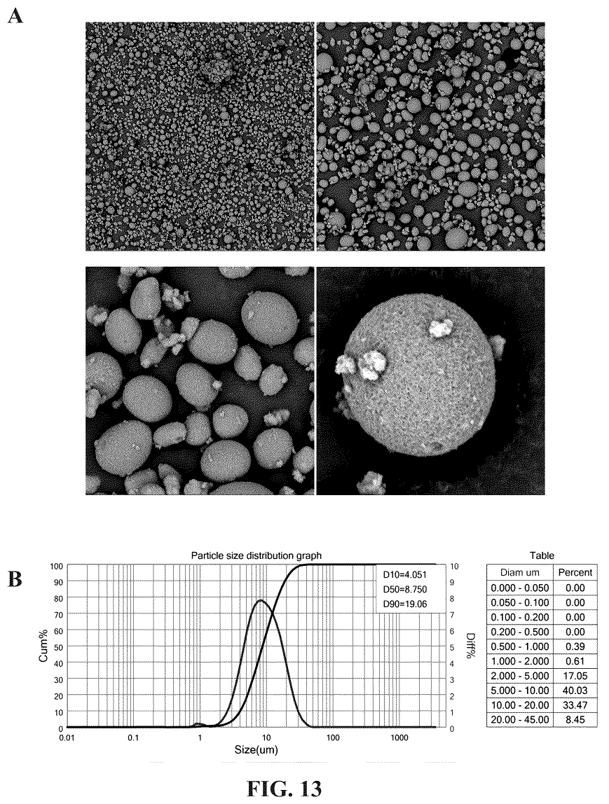

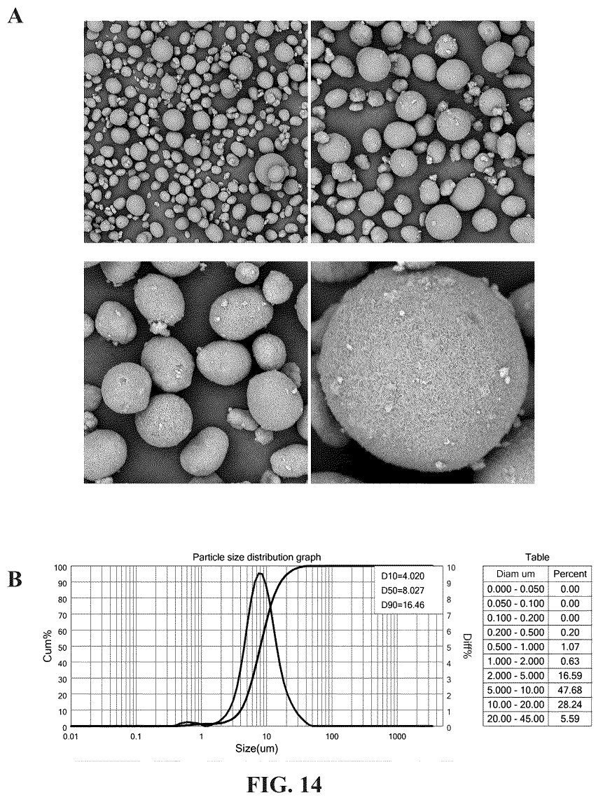

Similarly, aqueous MnSO₄, NiSO₄, and FeSO₄ hydrates were dissolved in water containing 0.05 molar equivalents of tartaric acid in a target ratio of Mn:Ni:Fe of about 0.375:0.25:0.375, and transition metal hydroxide pCAMs were co-precipitated following the procedures described above, using 4 M sodium hydroxide with 0.25 M ammonium hydroxide as the precipitating agent, while adding 1 M malic acid (Ex. SF-19). The ammonium hydroxide and the malic acid both act as chelating agents. The resulting product from Ex. SF-19 comprised roughly spherical particles and a density of about 1.25 g/mL, and a ratio of Mn:Ni:Fe of about 0.378:0.249:0.371 (see FIG. 12, Panel B). FIG. 13 provides electron micrographic images of the transition metal hydroxide pCAM particles (Panel A) produced in Ex. SF-18, and a graphical illustration of the particle size distribution (Panel B). FIG. 14 provides electron micrographic images of the transition metal hydroxide pCAM particles (Panel A) produced in Ex. SF-19, and a graphical illustration of the particle size distribution (Panel B). As is evident by comparing FIG. 13 to FIG. 14, the use of two chelating agents (ammonia and malic acid) resulted in a narrower particle size distribution (FIG. 14, Panel B) compared to using only malic acid as a chelating agent (FIG. 13, Panel B), albeit with less dense, larger particles.

### Example 5. Thermal Pre-treatment of Hydroxide pCAM Examples Sf-18 and Sf-19 to Form Transition Metal Oxide pCAMS

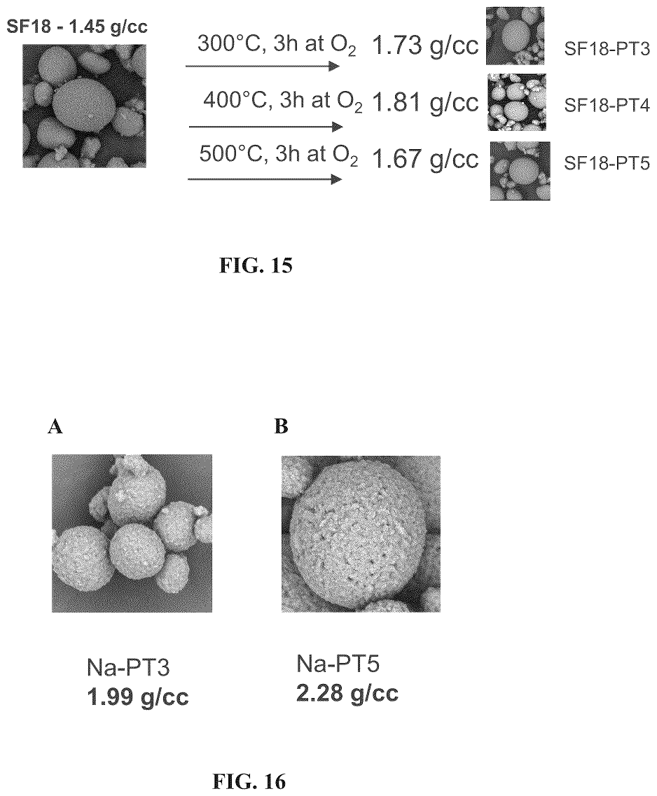

Samples of transition metal hydroxide pCAM Ex SF-18 were heated in an oxygen atmosphere for 3 hours at 300, 400 and 500 °C. FIG. 15 shows electron micrographic images of the transition metal oxide pCAM particles (Panel A, far right) resulting from thermal pre-treatment of Ex. SF-18 at three different temperatures (300, 400, and 500 °C), as well as the densities of the resulting respective transition metal oxide pCAMs, SF-18-PT3, SF-18-PT4, and SF-18-PT5. The thermal pre-treatment increased the density from 1.45 for the hydroxide pCAM to 1.72, 1.81, and 1.67 g/cc, respectively, for the transition metal oxide pCAMs produced at 300, 400, and 500 °C. The highest density was achieved at 400 °C (1.81 g/cc).

### Example 6. Effect of Thermal Pre-treatment on Sodium CAM Formation

Samples of transition metal oxide pCAMs SF-18-PT3 and SF-18-PT5 of Example 5 were calcined with sodium carbonate at 500 °C for 5 hours and 850 °C for 12 hours in an oxygen atmosphere to form corresponding sodium CAM products. The results are shown in FIG. 16, which provides electron micrographic images of sodium CAMs produced from transition metal oxide pCAMs SF-18-PT3 (Panel A) and SF-18-PT5 (Panel B) by calcination with sodium carbonate at 500 °C for about 5 hours and 850 °C for about 12 hours in an oxygen atmosphere. The dense transition metal oxide pCAMs produced CAMs with densities of 1.99 from SF-18-PT3 (Panel A) and 2.07 from SF 18-PT5 (Panel B). Thus, the resulting sodium CAMS were even higher density than the metal oxide precursors. Both the images in FIG. 16 are at a magnification of 20,000×, with the particles derived from SF 18-PT3 having diameters of about 3 to about 6 μm; while the main particle the right hand image, derived from SF 18-PT5, is about 12 μm in diameter. Thus, the lower temperature pre-treatment (300 °C) resulted in sodium CAM with a smaller particle size compared to the sodium CAM produced from the higher temperature (500 °C) pre-treatment.

Any references, including publications, patent applications, and patents cited herein are hereby incorporated by reference to the same extent as if each reference were individually and specifically indicated to be incorporated by reference and were set forth in its entirety herein. The use of the terms “a” and “an” and “the” and similar referents in the context of describing materials or methods (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The terms “consisting of” and “consists of” are to be construed as closed terms, which limit any compositions or methods to the specified components or steps, respectively, that are listed in a given claim or portion of the specification. In addition, and because of its open nature, the term “comprising” broadly encompasses compositions and methods that “consist essentially of” or “consist of” specified components or steps, in addition to compositions and methods that include other components or steps beyond those listed in the given claim or portion of the specification. Recitation of ranges of values herein are merely intended to serve as a shorthand method of referring individually to each separate value falling within the range, unless otherwise indicated herein, and each separate value is incorporated into the specification as if it were individually recited herein. All numerical values obtained by measurement (e.g., weight, concentration, physical dimensions, removal rates, flow rates, and the like) are not to be construed as absolutely precise numbers, and should be considered to encompass values within the known limits of the measurement techniques commonly used in the art, regardless of whether or not the term “about” is explicitly stated. All methods described herein can be performed in any suitable order unless otherwise indicated herein or otherwise clearly contradicted by context. The use of any and all examples, or exemplary language (e.g., “such as”) provided herein, is intended merely to better illuminate certain aspects of the materials or methods described herein and does not pose a limitation on the scope of the claims unless otherwise stated. No language in the specification should be construed as indicating any non-claimed element as essential to the practice of the claims.

Preferred embodiments are described herein, including the best mode known to the inventors for carrying out the claimed invention. Variations of those preferred embodiments may become apparent to those of ordinary skill in the art upon reading the foregoing description. The inventors expect skilled artisans to employ such variations as appropriate, and the inventors intend for the claimed invention to be practiced otherwise than as specifically described herein. Accordingly, the claimed invention includes all modifications and equivalents of the subject matter recited in the claims appended hereto as permitted by applicable law. Moreover, any combination of the above-described elements in all possible variations thereof is encompassed by the claimed invention unless otherwise indicated herein or otherwise clearly contradicted by context.

The embodiments of the invention in which an exclusive property or privilege is claimed are defined as follows:

1. A method of stabilizing an iron-containing transition metal sulfate solution to prevent precipitation of metal oxides therefrom; the method comprising adding about 0.005 to about 0.25 mol % of a stabilizing agent to an aqueous transition metal sulfate solution comprising iron sulfate in combination with at least one other transition metal sulfate, wherein the transition metal sulfate solution has a total transition metal concentration of about 0.2 to about 2 M; the stabilizing agent is a hydroxy-substituted carboxylic acid or a water-soluble salt thereof, and precipitation of the transition metal oxide is prevented for at least about 90 days at about 20 to 25 °C, after adding the stabilizing agent.

2. The method of claim 1, wherein the stabilizing agent is selected from the group consisting of glycolic acid, lactic acid, 2-hydroxybutyric acid, 2-hydroxycaproic acid, 2,2-bis(hydroxymethyl) propionic acid, gluconic acid, mucic acid, malic acid, tartaric acid, citramalic acid, 3-hydroxy-3-methylglutaric acid, oxalic acid, succinic acid, citric acid, a combination of any of the foregoing, and a water-soluble salt of any of the foregoing

3. The method of claim 1, wherein the stabilizing agent is selected from the group consisting of malic acid, oxalic acid, tartaric acid, a combination of any of the foregoing, and a salt of any of the foregoing.

4. The method of claim 1, wherein the at least one other transition metal sulfate comprises manganese sulfate, nickel sulfate, or a combination thereof.

5. A stabilized iron-containing transition metal sulfate solution comprising about 0.005 to about 0.02 mol % of a stabilizing agent in an aqueous transition metal sulfate solution comprising iron sulfate in combination with at least one other transition metal sulfate, wherein the transition metal sulfate solution has a total transition metal concentration of about 0.2 to about 2 M; the stabilizing agent is a hydroxy-substituted carboxylic acid, a multidentate carboxylic acid, or a water-soluble salt thereof, and the stabilized iron-containing transition metal sulfate solution is substantially free of precipitated transition metal oxide.

6. The solution of claim 5, wherein the stabilizing agent is selected from the group consisting of glycolic acid, lactic acid, 2-hydroxybutyric acid, 2-hydroxycaproic acid, 2,2-bis(hydroxymethyl) propionic acid, gluconic acid, mucic acid, malic acid, tartaric acid, citramalic acid, 3-hydroxy-3-methylglutaric acid, oxalic acid, succinic acid, citric acid, a combination of any of the foregoing, and a water-soluble salt of any of the foregoing.

7. The solution of claim 5, wherein the stabilizing agent is selected from the group consisting of malic acid, oxalic acid, tartaric acid, a combination of any of the foregoing, and a salt of any of the foregoing

8. The solution of claim 5, wherein the at least one other transition metal sulfate comprises manganese sulfate, nickel sulfate, or a combination thereof.

9. A method of coprecipitating an iron-containing transition metal cathode active material precursor salt (pCAM) from the stabilized iron-containing transition metal sulfate solution of claim 5; the method comprising the steps of:
(a) mixing a solution of a precipitating agent with the stabilized iron-containing transition metal sulfate solution at a temperature in the range of about 20 to about 50 °C, over a period of time sufficient to form a coprecipitate having a molar ratio of transition metals substantially the same as the ratio of transition metals in the iron-containing transition metal sulfate solution; and
(b) isolating the coprecipitated pCAM;
wherein the precipitating agent comprises an aqueous solution of an alkali metal salt selected from the group consisting of an alkali metal hydroxide, an alkali metal carbonate, and an alkali metal oxalate; and the pCAM comprises an iron-containing transition metal hydroxide, carbonate, or oxalate, respectively, based on the alkali metal salt used as the precipitating agent.

10. The method of claim 9, wherein the stabilizing agent is selected from the group consisting of glycolic acid, lactic acid, 2-hydroxybutyric acid, 2-hydroxycaproic acid, 2,2-bis(hydroxymethyl) propionic acid, gluconic acid, mucic acid, malic acid, tartaric acid, citramalic acid, 3-hydroxy-3-methylglutaric acid, oxalic acid, succinic acid, citric acid, a combination of any of the foregoing, and a water-soluble salt of any of the foregoing.

11. The method of claim 9, wherein the stabilizing agent is selected from the group consisting of malic acid, oxalic acid, tartaric acid, a combination of any of the foregoing, and a salt of any of the foregoing.

12. The method of claim 9, wherein the at least one other transition metal sulfate of the transition metal sulfate solution comprises manganese sulfate, nickel sulfate, or a combination thereof.

13. The method of claim 9, wherein the alkali metal salt is a sodium salt or a lithium salt.

14. The method of claim 9, wherein the mixing is achieved by simultaneously pumping the solution of the precipitating agent and the iron-containing transition metal sulfate solution into a vessel comprising an aqueous medium.

15. The method of claim 14, further comprising mixing an aqueous solution of a chelating agent with the stabilized iron-containing transition metal sulfate solution and the solution of the precipitating agent.

16. The method of claim 9, wherein the mixing is achieved by simultaneously pumping the solution of the precipitating agent and the iron-containing transition metal sulfate solution through a tubular continuous flow reactor or a Taylor vortex reactor.

17. The method of claim 16, further comprising mixing an aqueous solution of a chelating agent with the stabilized iron-containing transition metal sulfate solution and the solution of the precipitating agent.

18. The method of claim 9, further comprising mixing an aqueous solution of a chelating agent with the stabilized iron-containing transition metal sulfate solution and the solution of the precipitating agent.

19. The method of claim 9, further comprising forming a mixture of the pCAM isolated in step (b) with an alkali metal salt in a stoichiometric ratio required to prepare a cathode active material therefrom; and
(c) calcining the mixture at a temperature in the range of about 425 to about 950 °C for a period of time sufficient to form the cathode active material from the mixture; wherein the cathode active material is an alkali metal-transition metal oxide; and the alkali metal is selected from the group consisting of sodium and lithium.

20. A system for coprecipitating an iron-containing transition metal cathode active material precursor salt (pCAM) from a stabilized iron-containing transition metal sulfate solution; the system comprising:
a first reservoir containing the stabilized iron-containing transition metal sulfate solution;
a second reservoir containing an aqueous solution of a precipitating agent selected from the group consisting of an alkali metal hydroxide, an alkali metal carbonate, and an alkali metal oxalate;
a temperature-controlled reactor comprising a mixing apparatus within or ahead of the reactor;
a first pump adapted and arranged to continuously convey a flow of the stabilized iron-containing transition metal sulfate solution into the reaction vessel;
a second pump adapted and arranged to continuously convey a flow the solution of the precipitating agent into the reaction vessel at the same time as the first pump conveys the stabilized iron-containing transition metal sulfate solution into the reaction vessel;
wherein in use, the solution of the precipitating agent and the stabilized iron-containing transition metal sulfate solution are mixed together within or before entering the reactor and thereby react to form a coprecipitate of the pCAM; and the stabilized iron-containing transition metal sulfate solution comprises about 0.005 to about 0.25 mol % of a stabilizing agent in an aqueous transition metal sulfate solution comprising iron sulfate in combination with at least one other transition metal sulfate; the transition metal sulfate solution has a total transition metal concentration of about 0.2 to about 2 M; the stabilizing agent is a hydroxy-substituted carboxylic acid, a multidentate carboxylic acid, or a water-soluble salt thereof; and the stabilized iron-containing transition metal sulfate solution is substantially free of precipitated transition metal oxide.

21. The system of claim 20, wherein the reaction vessel is a tubular continuous flow reactor, and the mixing apparatus is an in-line static mixer situated ahead of the continuous flow reactor; or the reaction vessel is a Taylor vortex reactor which also acts as its own mixing apparatus.

22. The system of claim 20, further comprising:
a third reservoir containing an aqueous solution of a chelating agent; and
a third pump adapted and arranged to continuously convey a flow of the solution of the chelating agent into the reaction vessel at the same time as the first pump conveys the stabilized iron-containing transition metal sulfate solution into the reaction vessel;
wherein the alkali metal salt is a sodium salt or a lithium salt; and
wherein in use, the solution of the chelating agent, the solution of the precipitating agent, and the stabilized iron-containing transition metal sulfate solution are mixed together in the reaction vessel and thereby react form the coprecipitate of the pCAM.

23. The system of claim 20, wherein the stabilizing agent is selected from the group consisting of glycolic acid, lactic acid, 2-hydroxybutyric acid, 2-hydroxycaproic acid, 2,2-bis(hydroxymethyl) propionic acid, gluconic acid, mucic acid, malic acid, tartaric acid, citramalic acid, 3-hydroxy-3-methylglutaric acid, oxalic acid, succinic acid, citric acid, a combination of any of the foregoing, and a water-soluble salt of any of the foregoing.

24. The system of claim 20, wherein the stabilizing agent is selected from the group consisting of malic acid, oxalic acid, tartaric acid, a combination of any of the foregoing, and a salt of any of the foregoing

25. The system of claim 20, wherein the at least one other transition metal sulfate comprises manganese sulfate, nickel sulfate, or a combination thereof.
